(19) United States
(12) Patent Application Publication
(10) Pub. No.: US 2008/0139744 A1
(43) Pub. Date: Jun. 12, 2008

(54) Fatty Alcohol Polyglycol Ether Sulfates as Emulsifiers for Emulsion Polymerization

(76) Inventors: Uwe Held, Velbert (DE); Wolfgang Breuer, Oreland, PA (US); Thomas Mausberg, Erkrath (DE)

Correspondence Address: COGNIS CORPORATION;PATENT DEPARTMENT, 300 BROOKSIDE AVENUE, AMBLER, PA, 19002, US

(21) Appl. No.: 11/791,563

(22) PCT Filed: Nov. 12, 2005
(86) PCT No.: PCT/EP2005/012148

§ 371 Date: Dec. 12, 2007

(30) Foreign Application Priority Data
Nov. 25, 2004 (DE) 10 2004 056 853.7

(51) Int. Cl. C08F 2/16; C08G 65/34

(52) U.S. Cl. 524/800; 525/409

(57) ABSTRACT

The invention is directed to an emulsifier for emulsion polymerization. The emulsifier is obtained by alkoxylating a mixture of (a) 20% to 80% by weight of a fatty alcohol containing 8 to 22 carbon atoms and (b) 20% to 80% by weight of a ring opening product of a 1,2-epoxyalkane containing 8 to 18 carbon atoms with ethylene glycol, with from 5 to 100 mol ethylene oxide per equivalent of free OH groups in the sums of (a) and (b) and sulfation of the intermediate product obtained to form the emulsifier. The emulsifier provides a polymer similar with low coagulum and high stability.

### CROSS-REFERENCE TO RELATED APPLICATIONS

This application is filed under 35 U.S.C. § 371 claiming priority from Application PCT/EP2005/012148 filed on Nov. 12, 2005, which claims priority of German Application No. 10 2004 056 853.7 filed Nov. 25, 2004, the entire contents of which are incorporated herein by reference.

### FIELD OF THE INVENTION

This invention relates to the use of fatty alcohol polyglycol ether sulfates as emulsifiers for emulsion polymerization.

### BACKGROUND OF THE INVENTION

Alkyl polyoxyethylene sulfates and alkylphenol polyoxyethylene sulfates are known surfactants which are also suitable inter alia for stabilizing polymer dispersions. They are produced from native and petrochemical raw materials.

WO-A-03/037495 describes compositions which are obtainable by reacting a mixture of (a) 20 to 80% by weight of one or more fatty alcohols containing 8 to 22 carbon atoms and (b) 20 to 80% by weight of one or more ring opening products of 1,2-epoxyalkanes containing 8 to 18 carbon atoms with ethylene glycol with ethylene oxide, with the proviso that the quantity of ethylene oxide used is between 5 and 100 mol per mol free OH groups present in the sum of the compounds a) and b) used. These compositions, which are mixtures of nonionic surfactants, are suitable as emulsifiers for emulsion polymerization.

### BRIEF DESCRIPTION OF THE INVENTION

The problem addressed by the present invention was to provide compositions which would be suitable as emulsifiers for emulsion polymerization. These compositions would be free from organic solvents and would be soluble in water. Their solubility in water would be of a high level so that the compositions could be formulated in the supply form of stable water-based concentrates. In addition, the compositions would be distinguished by favorable ecotoxicological properties and also by improved properties in regard to polymerization and in the use of the latices obtained. The improvement would be aimed at an increase in stabilization during the polymerization process and an improvement in the stabilities of the dispersions towards electrolytes and temperature influences. The compatibility of the dispersion with calcium carbonate, for example for applications in the field of paper, would also be improved.

The present invention relates to the use of compositions obtainable by reaction of a mixture of
a) 20 to 80% by weight of one or more fatty alcohols containing 8 to 22 carbon atoms and
b) 20 to 80% by weight of one or more ring opening products of 1,2-epoxyalkanes containing 8 to 18 carbon atoms with ethylene glycol
   with ethylene oxide,
   with the proviso that the quantity of ethylene oxide used is between 5 and 100 mol per mol free OH groups present in the sum of the compounds a) and b) used, and subsequent sulfation of the intermediate product obtained as emulsifiers for emulsion polymerization.

The compositions according to the invention are obtainable in a two-stage process. The first step comprises reacting a mixture of the two classes of compounds (a) and (b) with ethylene oxide. The resulting intermediate products are sulfated in a second step. It is pointed out that the intermediate products of the first step are disclosed in the above-cited WO-A-03/037495. It is further pointed out that sulfation in the context of the present invention, in line with normal usage by the expert, means the conversion of the alcoholic OH groups of the intermediate product mentioned into (anionic) sulfate groups —OSO₃(M^{w})_{1/w,} where M is a cation and w is the valency of the cation. M is preferably lithium, sodium or potassium. The group —OSO₃Na is particularly preferred as the sulfate group.

### DETAILED DESCRIPTION OF THE INVENTION

The species of the compositions according to the invention belong structurally to the class of fatty alcohol polyglycol ether sulfates. Examples of such species are:

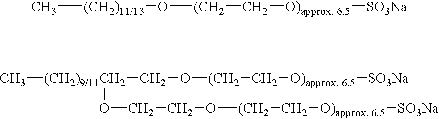

### Compounds (a)

Fatty alcohols containing 8 to 22 carbon atoms are known to the expert. They may be used individually or in admixture. Preferred fatty alcohols of this type are substantially saturated and unsaturated fatty alcohols which are understood to be fatty alcohols having an iodine value below 60. The following fatty alcohols or mixtures thereof with one another are most particularly preferred: lauryl alcohol, myristyl alcohol, cetyl alcohol, stearyl alcohol and oleyl alcohol.

### Compounds (b)

Ring opening products of 1,2-epoxyalkanes containing 8 to 18 carbon atoms with ethylene glycol are readily obtainable by subjecting the desired epoxyalkanes with to an oxirane ring opening reaction with ethylene glycol.

### Production of the Intermediate Products

The (co)ethoxylation of the two classes of compounds (a) and (b) mentioned takes place at elevated temperature and elevated pressure in the presence of suitable alkoxylation catalysts. The choice of the alkoxylation catalyst influences the breadth of the spectrum of addition products, the so-called homolog distribution, of the ethylene oxide onto the alcohol. Thus, addition products with a broad homolog distribution are obtained in the presence of catalytically active alkali metal alcoholates, such as sodium methylate, whereas so-called narrow-range products are obtained, for example, in the presence of hydrotalcite as catalyst.

### The Compositions According to the Invention

The compositions according to the invention may be used as sole emulsifiers (primary emulsifiers) in emulsion polymerizations. However, the compositions according to the invention may also be used together with (other) anionic or nonionic or cationic emulsifiers (or mixtures thereof).

The compositions according to the invention are preferably used in the form of surfactant concentrates as emulsifiers in emulsion polymerizations in a quantity of 0.2 to 10% by weight, preferably in a quantity of 0.5 to 5% by weight and more particularly in a quantity of 0.5 to 3% by weight, expressed as surfactant concentrate and based on the polymerization mixture.

The present invention also relates to a pourable liquid surfactant concentrate characterized by a content of 20 to 70% by weight of the above-mentioned compositions according to the invention and 30 to 80% by weight of water.

The pourable liquid surfactant concentrates according to the invention consist of surfactant mixture and water. The surfactant mixture is present in the surfactant concentrate according to the invention in quantities of 20 to 70% by weight and preferably in quantities of 20 to 50% by weight, based on the surfactant concentrate as a whole.

The surfactant concentrates according to the invention are liquid and pourable over broad temperature ranges. More particularly, the surfactant concentrates are liquid and pourable at 20° C. The lower limit of the temperature range in which the surfactant concentrates according to the invention are still liquid and pourable varies with their composition. In principle, the surfactant concentrates can be said to be pourable above their solidification points and preferably about 3° C. above their solidification points. The surfactant concentrates according to the invention have Höppler viscosities at 20° C. (DIN 53015) of 0.1 to 3 Pas.

The compositions according to the invention are generally suitable for use as emulsifiers in the production of water-containing latices, which are understood to be aqueous emulsions or dispersions of polymers and/or copolymers which are normally obtainable by emulsion polymerization. Basically, the nature of the polymers and copolymers in these water-containing latices is not subject to any particular restrictions. However, polymers and copolymers based on the following monomers are particularly preferred: acrylic acid, acrylates, butadiene, methacrylic acid, methacrylates, styrene, vinyl acetate and versatic acid vinyl ester.

The compositions according to the invention provide water-containing latices with, in particular, improved stability during the production process. This is reflected in a distinctly lower percentage coagulate content after polymerization by comparison with dispersions produced using conventional surfactants of the fatty alcohol ether sulfate species.

### EXAMPLES

Substances used:

Disponil® ELS 6.5: fatty alcohol polyglycol ether produced by reaction of a mixture of 70% by weight of a fatty alcohol containing 10 to 16 carbon atoms and 30% by weight of a ring opening product of 1,2-epoxyalkanes containing 12 to 14 carbon atoms with ethylene glycol with ethylene oxide, with the proviso that the quantity of ethylene oxide used is 6.5 mol per mol free OH groups present in the sum of the compounds a) and b) used (commercial product of Cognis Deutschland GmbH & Co. KG).

Oleum: oleum with an SO₃ content of 65% by weight.

### Example 1

Fatty alcohol polyglycol ether sulfate according to the invention (50% by weight active substance in water)

Raw materials:
2046.0 g Disponil® ELS 6.5
657.5 oleum (65% SO₃, corresponds to 427.4 g SO₃)
355.9 g sodium hydroxide (50% in water)
2241.9 g demineralized water

### Procedure:

2046.0 g Disponil® ELS 6.5 were reacted with 427,4 g SO₃ produced by evaporation of 657.5 g oleum in co-current flow in a tube reactor. The feed rate corresponded to 10 g/min. of the Disponil® ELS 6.5 and 3.21 g/min. oleum. The reactor temperature was adjusted to 30° C. The acidic intermediate product formed was neutralized while stirring in a receiving vessel containing a mixture of 355.9 g 50% sodium hydroxide and 2241.9 g demineralized water.

### Application Examples

### I. Improving Stability During the Production of Aqueous Polymer Dispersions

Examples 2 to 5 below illustrate the production of a polymer dispersion D1 based on vinyl acetate and VeoVa10 suitable as a binder for highly filled and low-filled systems. VeoVa10 (Shell) is the vinyl ester of Versatic 10, a synthesized branched monocarboxylic acid.

The following emulsifiers A to D were used:
Emulsifier A: fatty alcohol ether sulfate, Na salt, average of 4 EO units per OH group of the ethoxylated alcohol
Emulsifier B: fatty alcohol ether sulfate according to the invention, Na salt, average of 6.5 EO units per OH group of the ethoxylated alcohol
Emulsifier C: fatty alcohol ether sulfate, Na salt, average of 30 EO units per OH group of the ethoxylated alcohol
Emulsifier D: fatty alcohol ether sulfate according to the invention, Na salt, average of 30 EO units per OH group of the ethoxylated alcohol

The quantities of emulsifiers A to D used were all based on active substance of the particular emulsifier. Emulsifier B is the compound of which the production was described in Example 1. Emulsifier D was similarly produced using 30 EO instead of 6.5 EO.

### Example 2 (For Comparison)

Compositions used:
Receiving medium:

| | |
|---|---|
| Emulsifier A | 0.16 g |
| Water, deionized | 151.00 g |

### Feed 1:

| | |
|---|---|
| Potassium peroxodisulfate | 1.20 g |
| Water, deionized | 30.00 g |

### Feed 2:

| | | |
|---|---|---|
| Emulsifier A | 4.03 | g |
| Disodium tetraborate decahydrate | 0.51 | g |
| Potassium peroxodisulfate | 0.28 | g |
| Water, deionized | 263.79 | g |
| Methacrylic acid | 5.37 | g |
| VeoVa 10 | 26.83 | g |
| Butyl acrylate | 134.15 | g |
| Vinyl acetate | 370.25 | g |

### Feed 3:

| | |
|---|---|
| Isoascorbic acid | 0.27 g |
| Water, deionized | 2.39 g |

### Feed 4:

| | |
|---|---|
| Tert. butyl hydroperoxide (70%) | 0.27 g |
| Water, deionized | 2.39 g |

### Neutralization:

| | |
|---|---|
| Ammonia solution (12.5%) | 7.11 g |

### Procedure:

In a 2-liter polymerization reactor equipped with an anchor stirrer, reflux condenser, thermometer and 2 inlets, the receiving medium was heated under nitrogen at a jacket temperature of 80° C. to a temperature of 70° C. Feed 1 was quickly introduced at that temperature. Three minutes after feed 1 had been introduced, the introduction of feed 2 was started. The introduction time for feed 2 was 180 minutes. Five minutes after the introduction of feed 2 had started, the jacket temperature was reduced to 70° C. After the introduction, the whole was polymerized for 40 minutes. Feed 3 was quickly introduced. Five minutes later, feed 4 was introduced. After another 15 minutes' polymerization, the mixture was cooled to 35° C. and neutralized with semi-concentrated ammonia. After filtration through an 80 μm mesh sieve, the percentage coagulate content was determined.

### Example 3 (Invention)

Example 2 was repeated except that emulsifier A was replaced by emulsifier B.

### Example 4 (For Comparison)

Example 2 was repeated, except that emulsifier A was replaced by emulsifier C.

### Example 5 (Invention)

Example 2 was repeated, except that emulsifier A was replaced by emulsifier D.

### Results:

The percentage coagulate content of the dispersions of Examples 2 to 5 is set out in Table 1.

TABLE 1

| | Example 2 | Example 3 | Example 4 | Example 5 |
|---|---|---|---|---|
| Sieve coagulate in % | 1.31 | 0.11 | 22.84 | 2.47 |
| Total coagulate in % | 7.14 | 1.53 | 23.70 | 2.80 |

### II. Improving the Electrolyte Resistance of Aqueous Polymer Dispersions

Examples 6 and 7 below illustrate the production of a polymer dispersion D2 based on vinyl acetate and VeoVa10 suitable as a binder for highly filled and low-filled systems.

The following emulsifiers A and B were used:
Emulsifier A: fatty alcohol ether sulfate, Na salt, average of 4 EO units per OH group of the ethoxylated alcohol
Emulsifier B: fatty alcohol ether sulfate according to the invention, Na salt, average of 6.5 EO units per OH group of the ethoxylated alcohol

The quantities of emulsifiers A and B used were all based on active substance of the particular emulsifier. Emulsifier B is the compound of which the production was described in Example 1.

Examples 6 and 7 were each carried out in two variants.

### Example 6 (For Comparison)

Compositions used:

| | |
|---|---|
| Variant 1 | Variant 2 |

Receiving medium:

| | | | | |
|---|---|---|---|---|
| Emulsifier A | 0.27 | g | 0.54 | g |
| Water, deionized | 150.70 | g | 150.62 | g |

Feed 1:

| | | | | |
|---|---|---|---|---|
| Potassium peroxodisulfate | 1.20 | g | 1.20 | g |
| Water, deionized | 30.00 | g | 30.0 | g |

Feed 2:

| | | | | |
|---|---|---|---|---|
| Emulsifier A | 6.00 | g | 11.97 | g |
| Disodium tetraborate decahydrate | 0.51 | g | 0.51 | g |
| Potassium peroxodisulfate | 0.28 | g | 0.28 | g |
| Water, deionized | 262.01 | g | 255.85 | g |
| Methacrylic acid | 5.37 | g | 5.37 | g |
| VeoVa 10 | 26.83 | g | 26.83 | g |
| Butyl acrylate | 134.15 | g | 134.15 | g |
| Vinyl acetate | 370.25 | g | 370.25 | g |

Feed 3:

| | | | | |
|---|---|---|---|---|
| Isoascorbic acid | 0.27 | g | 0.27 | g |
| Water, deionized | 2.39 | g | 2.39 | g |

Feed 4:

| | | | | |
|---|---|---|---|---|
| Tert. butyl hydroperoxide (70%) | 0.27 | g | 0.27 | g |
| Water, deionized | 2.39 | g | 2.39 | g |

Neutralization:

| | | | | |
|---|---|---|---|---|
| Ammonia solution (12.5%) | 7.11 | g | 7.11 | g |

### Procedure:

In a 2-liter polymerization reactor equipped with an anchor stirrer, reflux condenser, thermometer and 2 inlets, the receiving medium was heated under nitrogen at a jacket temperature of 80° C. to a temperature of 70° C. Feed 1 was quickly introduced at that temperature. Three minutes after feed 1 had been introduced, the introduction of feed 2 was started. The introduction time for feed 2 was 180 minutes. Five minutes after the introduction of feed 2 had started, the jacket temperature was reduced to 70° C. After the introduction, the whole was polymerized for 40 minutes. Feed 3 was quickly introduced. Five minutes later, feed 4 was introduced. After another 15 minutes' polymerization, the mixture was cooled to 35° C. and neutralized with semi-concentrated ammonia. After filtration through an 80 μm mesh sieve, the percentage coagulate content was determined.

### Example 7 (Invention)

Example 6 was repeated, except that emulsifier A was replaced by emulsifier B.

### Results:

The percentage coagulate content of the dispersions of Examples 6 and 7 is set out in Tables 6 and 7.

### Electrolyte Stability

In addition, Table 2 illustrates the effects observed when various salt solutions are added to the dispersions by setting out the results of the electrolyte stability test. To this end, the two variants of the dispersions of Examples 6 and 7 were subjected to the following tests:

Quantities of 10 ml of the dispersion were mixed with 10 ml of an aqueous salt solution according to Table 2. If the dispersion remained stable (visual inspection), i.e. if electrolyte stability was achieved, this is indicated by a “+” in Table 2. If the dispersion did not remain stable (visual inspection), this is indicated by a “−”.

TABLE 2

| | Variant 1) | | Variant 2) | |
|---|---|---|---|---|
| | Example 6 | Example 7 | Example 6 | Example 7 |
| Sieve coagulate in % | 0.04 | 0.02 | 0.02 | 0.01 |
| Total coagulate in % | 0.24 | 0.12 | 0.19 | 0.15 |
| 1% NaCl solution | + | + | + | + |
| 10% NaCl solution | − | − | + | + |
| 1% CaCl₂ solution | − | + | + | + |
| 1% Al₂(SO₄)₃ solution | − | + | − | + |

With the dispersions based on the emulsifier according to the invention (i.e. the dispersions of Example 7), both the sieve coagulate content and also the total coagulate content and electrolyte stability were significantly better than was the case with the dispersions of Comparison Example 6.

We claim:

1. A composition obtained by reaction of a mixture comprising:
a) 20 to 80% by weight of at least one fatty alcohol containing 8 to 22 carbon atoms and
b) 20 to 80% by weight of at least one ring opening product of a 1,2-epoxyalkane containing 8 to 18 carbon atoms with ethylene glycol,
with ethylene oxide,
with the proviso that the quantity of ethylene oxide used is between 5 and 100 mol per mol free OH groups present in the sum of the compounds a) and b), and subsequent sulfation of the intermediate product obtained, whereby, an emulsifier for emulsion polymerization is formed.

2. A pourable liquid surfactant concentrate, comprising: 20 to 70% by weight of the composition claimed in claim 1 and 30 to 80% by weight water.

3. The composition of claim 1, wherein, the quantity of ethylene oxide used is from 5 to 30 mol of ethylene oxide per mol of free OH groups.

4. The composition of claim 3, wherein, the quantity of ethylene oxide used is 6.5 mol per mol of free OH groups.

5. A pourable liquid surfactant concentrate, comprising: 20 to 70% by weight of the composition claimed in claim 3 and 30 to 80% by weight water.

6. A pourable liquid surfactant concentrate, comprising: 20 to 70% by weight of the composition claimed in claim 4 and 30 to 80% by weight water.
